(19) United States
(12) Patent Application Publication
(10) Pub. No.: US 2022/0277338 A1
(43) Pub. Date: Sep. 1, 2022

(54) ADVERTISING BUDGET OPTIMIZATION DEVICE

(71) Applicant: NTT DOCOMO, INC., Chiyoda-ku (JP)

(72) Inventors: Tsukasa DEMIZU, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/638,078

(22) PCT Filed: Aug. 25, 2020
(86) PCT No.: PCT/JP2020/031976

§ 371 Date: Feb. 24, 2022

(30) Foreign Application Priority Data
Aug. 30, 2019 (JP) 2019-158310

(51) Int. Cl. G06Q 30/02

(52) U.S. Cl. CPC G06Q 30/0244; G06Q 30/0247; G06Q 30/0246

(57) ABSTRACT

An advertisement budget optimization device (1) includes an estimation unit (13) that estimates a cost per click of an advertisement for each predetermined unit period (specifically, one day) included in a delivery period of an advertisement campaign as a delivery target, and a determination unit (14) that determines an advertisement budget for each unit period so that a total number of clicks of the advertisement is maximized, based on the cost per click in each unit period estimated by the estimation unit (13) and a total budget for the advertisement campaign in the delivery period.

### TECHNICAL FIELD

One aspect of the present invention relates to an advertising budget optimization device.

### BACKGROUND ART

Patent Literature 1 discloses a technology for individually predicting an advertisement effect in each piece of advertisement content based on an advertisement effect of delivered advertisement content delivered in the past.

### CITATION LIST

### Patent Literature

[Patent Literature 1] Japanese Unexamined Patent Publication No. 2015-111382

### SUMMARY OF INVENTION

### Technical Problem

In the related art, for example, when an advertisement delivery period and a total budget are determined for a certain advertisement campaign, it is common to set a daily budget for the advertisement campaign depending on the advertisement delivery period and the total budget. Here, it is conceivable that a cost per click of the advertisement differs depending on days even when the advertisement campaign is the same Therefore, when the daily budget is set uniformly depending on the advertisement delivery period and the total budget, it is not possible to sufficiently increase a total number of clicks and maximize an advertisement delivery effect.

One aspect of the present invention has been made in view of the above circumstances, and an object of the present invention is to maximize a delivery effect of an advertisement.

### Solution to Problem

An advertisement budget optimization device according to an aspect of the present invention includes an estimation unit configured to estimate a cost per click of an advertisement for each predetermined unit period included in a delivery period of an advertisement campaign as a delivery target; and a determination unit configured to determine an advertisement budget for each unit period so that a total number of clicks of the advertisement is maximized, based on the cost per click in each unit period estimated by the estimation unit and a total budget for the advertisement campaign in the delivery period.

In the advertisement budget optimization device according to an aspect of the present invention, the cost per click of the advertisement for each predetermined unit period (for example, one day) is estimated, and the advertisement budget for each unit period is determined so that the total number of clicks of the advertisement is maximized, based on the cost per click and the total budget for the advertisement campaign. That is, for example, control is performed so that a larger advertisement budget is set in a period in which the cost per click is lower and the total number of clicks is maximized. According to such an advertisement budget optimization device 1, since how much of the advertisement budget should be invested in which period to maximize the total number of clicks is appropriately derived by estimating the cost per click in each unit period, it is possible to maximize a delivery effect of the advertisement within a predetermined delivery period and a total budget. Further, since the budget allocation can be automatically performed when the total budget is given, it is possible to curb human costs.

Advantageous Effects of Invention

According to an aspect of the present invention, it is possible to maximize an effect of delivery of advertisements.

### BRIEF DESCRIPTION OF DRAWINGS

FIG. 1 is a diagram illustrating an overview of an advertisement budget optimization device according to an embodiment of the present invention.

FIG. 2 is a diagram illustrating a functional configuration of the advertisement budget optimization device.

FIG. 3 is a diagram illustrating an image of daily cost per click estimation.

FIG. 4 is a diagram illustrating processing for allocating a budget to each advertisement group.

FIG. 5 is a flowchart illustrating processing that is executed by the advertisement budget optimization device.

FIG. 6 is a diagram illustrating a hardware configuration of the advertisement budget optimization device.

### DESCRIPTION OF EMBODIMENTS

Hereinafter, embodiments of the present invention will be described in detail with reference to the accompanying drawings. In description of the drawings, the same or equivalent elements are denoted by the same reference numerals, and repeated description is omitted.

An advertisement budget optimization device according to the present embodiment is a device that optimizes a budget for online advertisement that a company performs using the Internet for marketing of products or services, for example. The advertisement budget optimization device optimizes an advertisement budget for each predetermined unit period (for example, one day) for an advertisement campaign in which a delivery period and a total budget are determined, for example.

The advertisement campaign is an item that is set, for example, in units of an advertisement activity of a product or service to be advertised. Only one advertisement campaign may be set for the same product or service, or a plurality of advertisement campaigns may be set. In the advertisement campaign, one or a plurality of advertisement groups are set. The advertisement group is an item set for each type of approach to a delivery target (user). The advertisement group may be set, for example, for each type of approach (targeted user) according to a sex of users, an age of the users, an area of residence of the users, a delivery time of an advertisement, and the like. One or a plurality of advertisements are set in each advertisement group. The advertisement may be an advertisement using a still image, an advertisement using a moving image, a text advertisement, or the like.

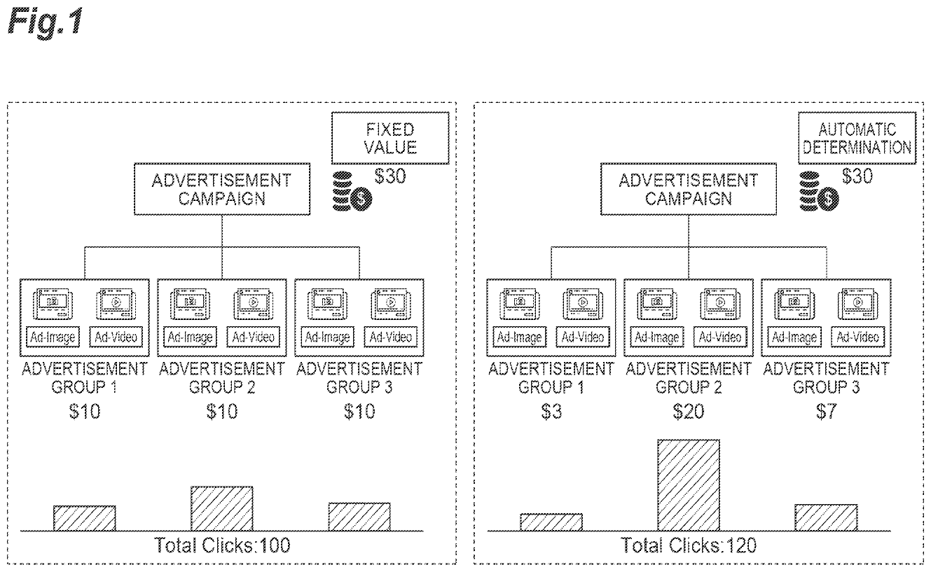

An overview of the advertisement budget optimization device according to the present embodiment will be described with reference to FIG. 1. FIG. 1 is a diagram illustrating an overview of the advertisement budget optimization device 1 according to the present embodiment. In FIG. 1, a left side illustrates an advertisement budget setting image according to a comparative example (the related art), and a right side illustrates an advertisement budget setting image in the advertisement budget optimization device 1 according to the present embodiment. As illustrated on the left of FIG. 1, in an advertisement budget setting of the related art, a daily budget for the advertisement campaign is determined as a fixed value depending on the advertisement delivery period and the total budget for the advertisement campaign ($30 in an example shown on the left of FIG. 1). That is, for example, when the advertisement delivery period of the advertisement campaign is 10 days and the total budget is 300 dollars, the advertisement budget for each day of the advertisement campaign is a fixed value of 30 dollars obtained by dividing the total budget by the advertisement delivery period. For example, when there are three advertisement groups in the advertisement campaign as illustrated on the left of FIG. 1, a budget for each advertisement group for each day is 10 dollars obtained by dividing 30 dollars that is an advertisement budget for one day by 3. Thus, when the advertisement budget is evenly allocated to the respective advertisement groups of each day, it is not possible to efficiently increase a total number of clicks because a cost per click of the advertisement differs depending on days and advertisement groups.

On the other hand, in the advertisement budget setting in the advertisement budget optimization device 1 according to the present embodiment, first, a cost per click of the advertisement of each day included in the advertisement delivery period of the advertisement campaign is estimated, and the advertisement budget for each day is determined so that a total number of clicks of the advertisement in the advertisement delivery period is maximized, based on the estimated cost per click and the total budget for the advertisement campaign. In an example illustrated on the right of FIG. 1, an advertisement budget for a certain day is determined to be 30 dollars. In the advertisement budget setting of the advertisement budget optimization device 1 according to the present embodiment, allocation of the advertisement budget is performed, for example, so that a larger budget is allocated to an advertisement group with a lower cost per click instead of the advertisement budget being evenly allocated to the respective advertisement groups included in the advertisement campaign, as illustrated on the right of FIG. 1. Thus, in the advertisement budget setting according to the advertisement budget optimization device 1 according to the present embodiment, the cost per click of the advertisement for each day is estimated, and the advertisement budget for each day is determined so that the total number of clicks of the advertisement is maximized, and a larger budget is allocated to the advertisement group with a lower cost per click, thereby maximizing the total number of clicks and maximizing delivery effects of the advertisement. For example, in the example illustrated in FIG. 1, the total number of clicks is 100 in the advertisement budget setting according to the comparative example, whereas the total number of clicks is 120 in the advertisement budget setting according to the present embodiment. Hereinafter, a functional configuration of the advertisement budget optimization device 1 will be described in detail.

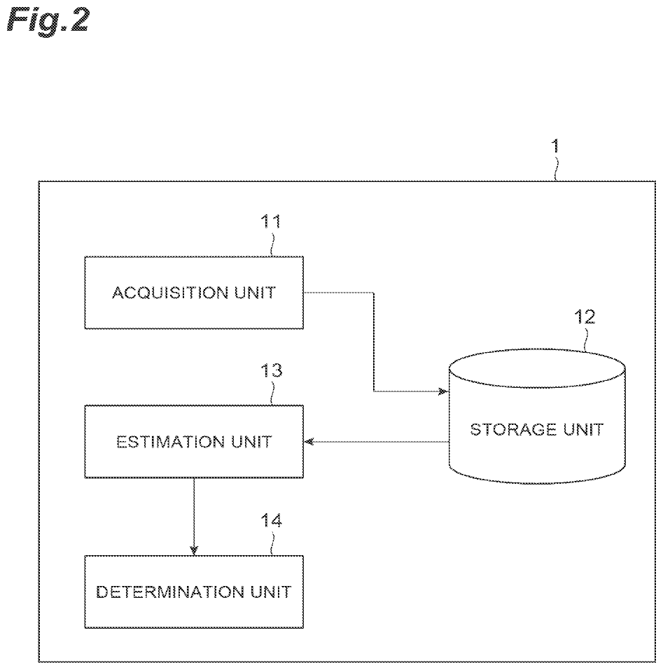

FIG. 2 is a diagram illustrating a functional configuration of the advertisement budget optimization device 1 according to the present embodiment. The advertisement budget optimization device 1 may be a device that delivers advertisements by itself or a device that can communicate with a device that delivers advertisements, but only functions related to advertisement budget optimization processing of the advertisement budget optimization device 1 will be described in the present embodiment. The advertisement budget optimization device 1 includes an acquisition unit 11, a storage unit 12, an estimation unit 13, and a determination unit 14 as functional components thereof

The acquisition unit 11 acquires information that is used for a determination of a daily advertisement budget. The acquisition unit 11 acquires, for example, an advertisement delivery period T of the advertisement campaign as a delivery target, a total budget B of the advertisement campaign in the advertisement delivery period T, a lower limit 1 and an upper limit u of the daily advertisement budget, and an actual value D of the daily cost per click in a past campaign having a high relevance to the advertisement campaign as a delivery target. The past campaign having a high relevance to the advertisement campaign as a delivery target is, for example, a past campaign of an advertiser that is same as that of the advertisement campaign as a delivery target, a past campaign with a product or service to be advertised similar to that of the advertisement campaign as a delivery target, a past campaign with an assumed user of the product or service to be advertised similar to that of the advertisement campaign as a delivery target, or a past campaign with an advertisement delivery time and period similar to that of the advertisement campaign as a delivery target. The acquisition unit 11 may acquire each piece of information described above from, for example, an external device (not illustrated) or may acquire the information in response to an input from a person in charge of an advertisement delivery business operator, or the like. The acquisition unit 11 stores each acquired piece of information in the storage unit 12. The storage unit 12 is a database that stores each piece of information acquired by the acquisition unit 11.

The estimation unit 13 estimates the cost per click of the advertisement for each predetermined unit period (specifically, one day) included in the advertisement delivery period T of the advertisement campaign as a delivery target. The estimation unit 13, for example, may acquire the actual value D of the daily cost per click in the past campaign having a high relevance to the advertisement campaign as a delivery target from the storage unit 12, and estimate the cost per click of the daily advertisement campaign as a delivery target based on the daily cost per click at each delivery time shown in the actual value D.

The estimation unit 13 estimates a daily cost per click (posterior delivery) of an advertisement cam={(^{x(n)}, y⁽ⁿ⁾)}^{N}ₙ₌₁ of the past campaign using, for example, a Gaussian process. x⁽ⁿ⁾ is, for example, the number of elapsed days from a delivery start date included in the actual value D of the past campaign, and y⁽ⁿ⁾ is an actual value of the cost per click on a delivery date x⁽ⁿ⁾. The estimation using the Gaussian process can be regarded as a regression problem for obtaining an unknown function f indicating a relationship of an input x⁽ⁿ⁾ and an output y⁽ⁿ⁾ and can be performed by a known method of the related art.

The estimation unit 13 may estimate the cost per click of a daily advertisement in a period before advertisement delivery in the advertisement delivery period T each time a unit period (specifically, one day) elapses after the delivery of the advertisement for the advertisement campaign as a delivery target has been started. In this case, the estimation unit 13 may estimate the cost per click of the daily advertisement in the period before advertisement delivery in the advertisement delivery period T in consideration of the cost per click of the daily advertisement of the advertisement campaign as a delivery target for a period in which the delivery of the advertisement is completed (that is, in consideration of an actual delivery result of the advertisement campaign as a delivery target).

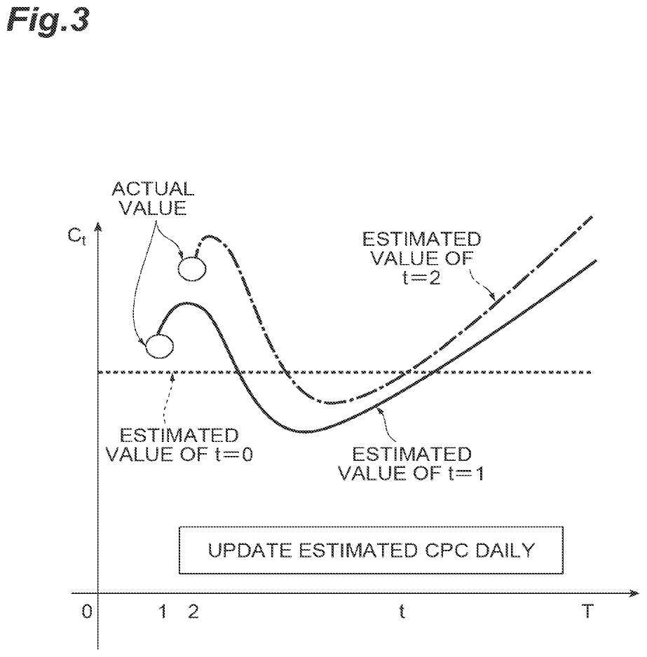

FIG. 3 is a diagram illustrating an image of estimation of a daily cost per click. In FIG. 3, a horizontal axis indicating the number of elapsed days t from a delivery start date, and a vertical axis indicates a cost per click Ct. In the example illustrated in FIG. 3, for example, an estimated value of the cost per click Ct of each day is the same value in the delivery start date (t=0). When one day has elapsed (t=1), the cost per click of the daily advertisement from a second day is estimated in consideration of the actual value of the cost per click of a first day on which the delivery of the advertisement is completed. Similarly, when two days have elapsed since the delivery start date (t=2), the cost per click of the daily advertisement from a third day is estimated in further consideration of an actual value of the cost per click of the second day in which the delivery of the advertisement is completed. Thus, in the example illustrated in FIG. 3, the estimated value of the cost per click is updated every day.

The determination unit 14 determines a daily advertisement budget so that the total number of clicks of the advertisement is maximized, based on the cost per click in each unit period (specifically, one day) estimated by the estimation unit 13 and the total budget B of the advertisement campaign stored in the storage unit 12. The determination unit 14 maximizes the total number of clicks of the advertisement in the advertisement delivery period, for example, by increasing the advertisement budget when a day has a lower cost per click. Thus, it is possible to effectively increase the total number of clicks by increasing the advertisement budget of a day with high cost-effectiveness (a day with a low cost per click). The determination unit 14 may acquire the lower limit 1 and the upper limit u of the daily advertisement budget stored in the storage unit 12, and deter⁻mine the daily advertisement budget so that the total number of clicks of the advertisement is maximized in a range in which the advertisement budget for each day is in a range from the lower limit 1 to the upper limit u.

The determination unit 14 may perform allocation of an advertisement budget to each advertisement group so that a larger budget is allocated to the advertisement group with a lower cost per click based on an actual value of a cost per click for each advertisement group in a period in which the delivery of the advertisement has already been completed.

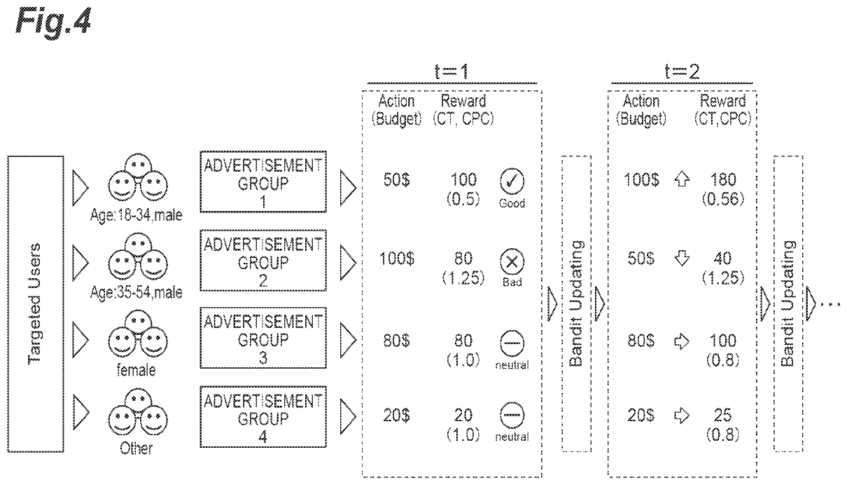

FIG. 4 is a diagram illustrating processing for allocating a budget to each advertisement group. In an example illustrated in FIG. 4, advertisement groups 1 to 4 are set for respective targeted users. Advertisement group 1 is an advertisement group in which male aged between 18 to 34 are targeted users. Advertisement group 2 is an advertisement group in which male aged between 35 to 64 are targeted users. Advertisement group 3 is an advertisement group in which female are targeted users. Advertisement group 4 is an advertisement group in which other attributes are targeted users. Now, an advertisement budget for a first day is 250 dollars, 50 dollars are allocated to advertisement group 1, 100 dollars to advertisement group 2, 80 dollars to advertisement group 3, and 20 dollars to advertisement group 4 as budgets for the respective advertisement groups, advertisement delivery is performed, and as actual values of the first day (t=1), the number of clicks of advertisement group 1 is 100, the cost per click is 0.5 dollars, the number of clicks of advertisement group 2 is 80, the cost per click is 1.25 dollars, the number of clicks of advertisement group 3 is 80, the cost per click is 1.0 dollar, the number of clicks of advertisement group 4 is 20, and the cost per click is 1.0 dollar, as illustrated in FIG. 4.

For example, advertisement group 1 with a relatively low cost per click of 0.5 dollars is determined to be an “advertisement group with a good cost per click”, advertisement groups 3 and 4 with an average cost per click of 1.0 dollars are determined to be “advertisement groups with an average cost per click”, and advertisement group 2 with a relatively high cost per click of 1.25 dollars is determined to be an “advertisement group with a bad cost per click”. In this case, processing for increasing the budget for advertisement group 1 that is an “advertisement group with a good cost per click” to 100 dollars, decreasing the budget for advertisement group 2 that is an “advertisement group with a bad cost per click” to 50 dollars, and maintaining the budget for advertisement groups 3 and 4 that are “advertisement groups with an average cost per click” as it is in consideration of the actual value of the first day when the advertisement budget for the next day (t=2) is 250 dollars as in the first day is performed. Accordingly, for example, in the actual value of the first day (t=1), the total number of clicks is 100+80+80+20=280, whereas in the actual value of the second day (t=2), the total number of clicks is 180+40+100+25=345, and even when the advertisement budget is the same on both days, it is possible to increase the total number of clicks. Thus, the determination unit 14 may perform allocation of the advertisement budget using a bandit algorithm for maximizing a reward (here, the total number of clicks) in a certain period by combining search (selecting an option to acquire information other than currently known information) and utilization (selecting an option for maximizing profit from the currently known information) and performing repetitive processing.

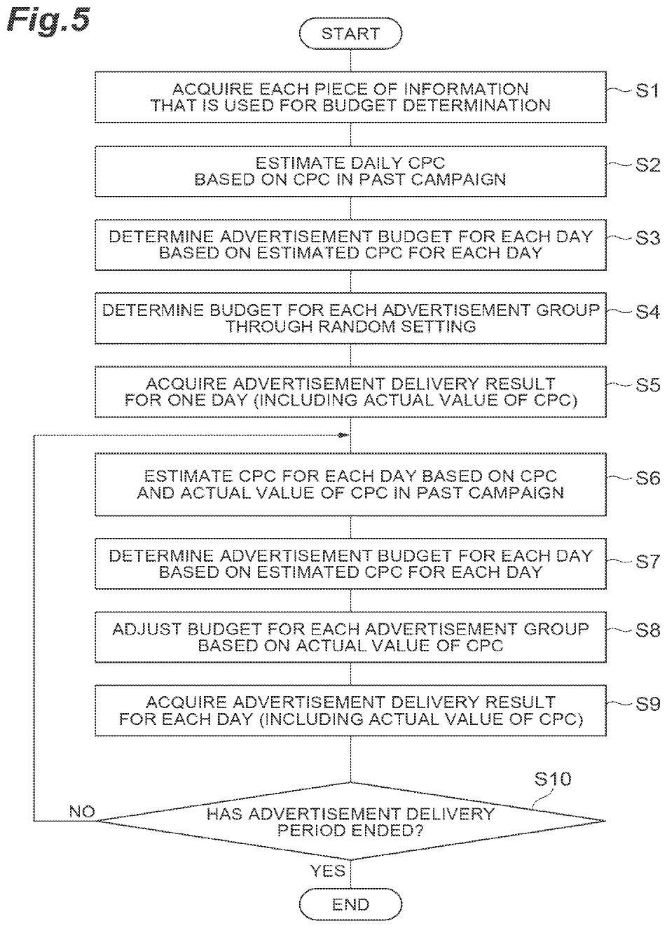

Next, processing that is executed by the advertisement budget optimization device 1 will be described with reference to FIG. 5. FIG. 5 is a flowchart illustrating processing that is executed by the advertisement budget optimization device 1.

As illustrated in FIG. 5, the advertisement budget optimization device 1 first acquires each piece of information that is used for a determination of the daily advertisement budget (step S1). Specifically, the advertisement budget optimization device 1 acquires and stores the advertisement delivery period T of the advertisement campaign as a delivery target, the total budget B of the advertisement campaign in the advertisement delivery period T, the lower limit 1 and the upper limit u of the daily advertisement budget, and the actual value D of the daily cost per click in the past campaign having a high relevance to the advertisement campaign as a delivery target. Now, it is assumed that the advertisement delivery period T=10, the total budget B=100 dollars, the lower limit 1 of the advertisement budget=5 dollars, the upper limit u=20 dollars, and an actual value of the daily cost per click in the past campaign D=(xₙ, yₙ)}^{T}ₙ₌₁.

Subsequently, the advertisement budget optimization device 1 estimates the daily cost per click from the first day (t=1) based on the actual value D of the daily cost per click in the past campaign (step S2). The advertisement budget optimization device 1 estimates the cost per click Ct such as a cost per click C1=5 at t=1, a cost per click C2=8 at t=2, a cost per click C9=4 at t=9, and a cost per click C10=3 at t=10, for example, using Gaussian process regression.

Subsequently, the advertisement budget optimization device 1 determines the advertisement budget for each day based on the estimated cost per click Ct for each day (step S3). Specifically, the advertisement budget optimization device 1 obtains the advertisement budget for each day in which Equation (3) is maximized while Equations (1) and (2) below is satisfied, by solving a linear programming problem. In Equations (1) to (3) below, B is the total budget for the advertisement campaign, T is the advertising delivery period of the advertisement campaign, bt is an advertisement budget for a t-th day, 1 is the lower limit of the advertisement budget for each day, u is the upper limit of the advertisement budget for each day, and Ct is an estimated value of a cost per click on the t-th day.

[Math. 1]

B=Σₜ₌₁^{T}bt (1)

[Math. 2]

l<bt≤u, t=1, . . . , T (2)

[Math. 3]

Σₜ₌₁^{T}bt/Ct (3)

Now, since the total budget B=100 dollars and the advertisement delivery period T=10, 100=b1+b2+ . . . +b9 +b10 from Equation (1). Further, since the lower limit 1 of the advertisement budget=5 dollars and the upper limit u=20 dollars, 5≤bt≤20 from Equation (2). Further, Equation (3) becomes b1/5+b2/8+ . . . +b9/4+b1/3 in consideration of a value of the estimated cost per click Ct described above. The advertisement budget optimization device 1 obtains the advertisement budget for each day in which Equation (3) is maximized while Equations (1) and (2) are satisfied.

Subsequently, the advertisement budget optimization device 1 allocates the advertisement budget for each day to each advertisement group through, for example, random setting (step S4). The advertisement budget optimization device 1 executes the advertisement campaign (distributes an advertisement) according to the determined advertisement budget, and acquires an advertisement delivery result (step S5). Specifically, the advertisement budget optimization device 1 acquires an actual value C1 of the cost per click of the first day when the advertisement is delivered with an advertisement budget b1 for the first day. For example, when the advertisement budget b1=10, the actual value C1′ is acquired as the actual value C1′ of the cost per click of the first day=6.

Next, the advertisement budget optimization device 1 estimates the daily cost per click from the second day (t=2), based on the actual value D of the daily cost per click in the past campaign and the actual value C1′ of the cost per click of the first day (step S6). The advertisement budget optimization device 1 estimates the cost per click Ct such as a cost per click C2=9 at t=2, a cost per click C9=5 at t=9, and a cost per click C10=3 at t=10, for example, using Gaussian process regression.

Subsequently, the advertisement budget optimization device 1 determines the advertisement budget for each day based on the estimated cost per click Ct for each day (step S7). Specifically, the advertisement budget optimization device 1 obtains the advertisement budget for each day in which Equation (6) is maximized while Equations (4) and (5) below is satisfied, by solving a linear programming problem. Equation (4) is substantially the same as Equation (1), Equation (5) is substantially the same as Equation (2), and Equation (6) is substantially the same as Equation (3), but the equations differ in that the equations are equations for determining advertisement budgets for second and subsequent days in consideration of an actual value for a first day.

[Math. 4]

B=Σₜ₌₂^{T}bt+b (4)

[Math. 5]

l≤bt≤u, t=2, . . . , T (5)

[Math. 6]

Σₜ₌₂^{T}bt/Ct (6)

Now, since the total budget B=100 dollars and the advertisement budget b1 for the first day=10 dollars, 100=(b2+ . . .+b9+b10) +10 from Equation (4). Further, since the lower limit 1 of the advertisement budget=5 dollars and the upper limit u=20 dollars, 5≤bt≤20 from Equation (5). Further, Equation (6) becomes b2/9+ . . . +b9/5+b10/3 in consideration of a value of the estimated cost per click Ct described above. The advertisement budget optimization device 1 obtains the advertisement budget for each day in which Equation (6) is maximized while Equations (4) and (5) are satisfied.

Subsequently, the advertisement budget optimization device 1 allocates the advertisement budget for each day to each advertisement group, for example, based on the actual value of the cost per click of the first day of each advertisement group (step S8). That is, the advertisement budget optimization device 1 performs adjustment to increase the budget for the “advertisement group with a good cost per click” and performs adjustment to decrease the budget for the “advertisement group having a bad cost per click”. The advertisement budget optimization device 1 executes the advertisement campaign (distributes an advertisement) according to the determined advertisement budget, and acquires an advertisement delivery result (step S9). Specifically, the advertisement budget optimization device 1 acquires an actual value C2′ of the cost per click on the second day when the advertisement is delivered with the advertisement budget b2 of the second day. For example, when the advertisement budget b2=5, the actual value C2′ is acquired as the actual value C2′ of the cost per click of the second day=9.

Subsequently, the advertisement budget optimization device 1 determines whether or not the advertisement delivery period T=10 has ended (step S10). The processing of steps S5 to S10 is repeatedly performed until it is determined in step S10 that the advertisement delivery period has ended. In this case, Equations (4) to (6) change appropriately over the period (change over time, similar to change from Equations (1) to (3) to Equations (4) to (6)). When it is determined in step S10 that the advertisement delivery period has ended, the processing ends.

Next, an operation and effect of the advertisement budget optimization device 1 according to the present embodiment will be described.

The advertisement budget optimization device 1 according to the present embodiment includes an estimation unit 13 that estimates a cost per click of an advertisement for each predetermined unit period (specifically, one day) included in the delivery period of the advertisement campaign as a delivery target, and a determination unit 14 that determines the advertisement budget for each unit period so that the total number of clicks of the advertisement is maximized, based on the cost per click in each unit period estimated by the estimation unit 13 and the total budget for the advertisement campaign in the delivery period.

In the advertisement budget optimization device 1 according to the present embodiment, the cost per click of the advertisement for each predetermined unit period (for example, one day) is estimated, and the advertisement budget for each unit period is determined so that the total number of clicks of the advertisement is maximized, based on the cost per click and the total budget for the advertisement campaign. That is, for example, control is performed so that a larger advertisement budget is set in a period in which the cost per click is lower and the total number of clicks is maximized. According to such an advertisement budget optimization device 1, since how much of the advertisement budget should be invested in which period to maximize the total number of clicks is appropriately derived by estimating the cost per click in each unit period, it is possible to maximize a delivery effect of the advertisement within a predetermined delivery period and a total budget. Further, a technical effect of reduction of a processing load in a processor such as a CPU related to a determination of the advertisement budget is also achieved by determining the advertisement budget for each unit period from information that can be estimated relatively easily, such as the cost per click in each unit period.

In the advertisement budget optimization device 1, the estimation unit 13 estimates the cost per click in each unit period of the advertisement campaign as a delivery target based on the cost per click in each unit period in each delivery time of the advertisement campaign having a high relevance to the advertisement campaign as a delivery target and delivered in the past. With such a configuration, it is possible to estimate a cost per click in each unit period of the advertisement campaign as a delivery target with high accuracy based on a delivery result (the cost per click in each unit period) of the advertisement campaign having a high relevance delivered in the past.

In the advertisement budget optimization device 1, the estimation unit 13 estimates the cost per click of the advertisement in each unit period in the period before advertisement delivery in the delivery period each time the unit period elapses after the delivery of the advertisement for the advertisement campaign as a delivery target is started. It is possible to estimate the cost per click in each unit period before advertisement delivery with higher accuracy in consideration of a situation after advertisement delivery by estimating the cost per click in each unit period before advertisement delivery each time the unit period elapses.

In the advertisement budget optimization device 1, the estimation unit 13 estimates the cost per click of the advertisement in each unit period in the period before advertisement delivery in the delivery period, based on the cost per click of the advertisement in each unit period for the period in which the delivery of the advertisement is completed. With such a configuration, it is possible to estimate the cost per click in each unit period before advertisement delivery with higher accuracy in consideration of an actual delivery result (cost per click in each unit period) for the advertisement campaign.

In the advertisement budget optimization device 1, the advertisement campaign includes a plurality of advertisement groups set for respective types of approach to users, and the determination unit 14 performs allocation of the advertisement budget to each of the advertisement groups so that a larger budget is allocated to the advertisement group with a lower cost per click, based on the cost per click of each advertisement group for the period in which the delivery of the advertisement is completed. With such a configuration, it is possible to perform budget allocation so that the total number of clicks is maximized within the advertisement budget for each unit period, in consideration of the actual delivery result (the cost per click for each advertisement group) for the advertisement campaign.

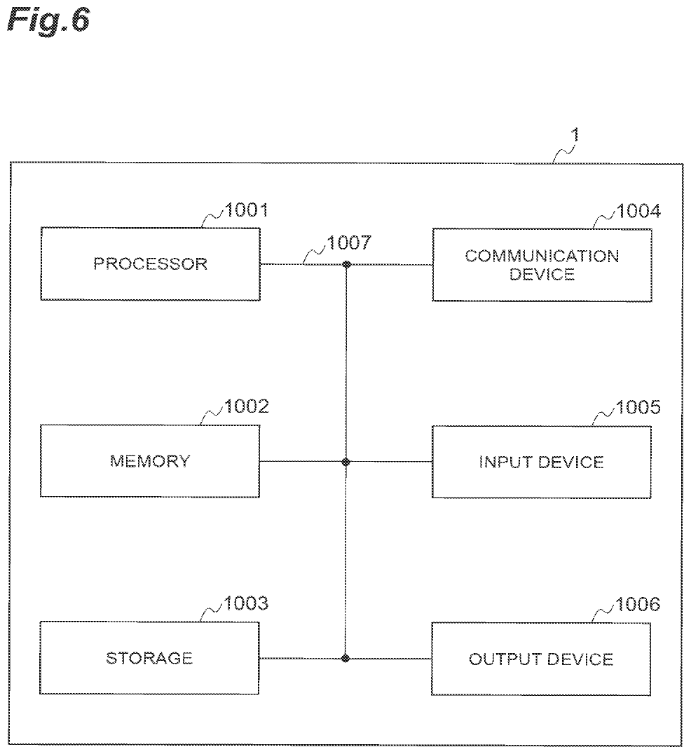

Finally, a hardware configuration of the advertisement budget optimization device 1 will be described with reference to FIG. 6. The above-described advertisement budget optimization device 1 may be physically configured as a computer device including a processor 1001, a memory 1002, a storage 1003, a communication device 1004, an input device 1005, an output device 1006, a bus 1007, and the like.

In the following description, a word “device” can be read as a circuit, device, unit, or the like. The hardware configuration of the advertisement budget optimization device 1 may be configured to include one or a plurality of the devices illustrated in the figure or may be configured not to include some of the devices.

Respective functions of the advertisement budget optimization device 1 are realized when predeteimined software (program) is loaded onto hardware such as the processor 1001 and the memory 1002 and the processor 1001 performs calculation to control communication using the communication device 1004 and reading and/or writing of data in the memory 1002 and the storage 1003.

The processor 1001 operates, for example, an operating system to control the entire computer. The processor 1001 may be configured of a central processing unit (CPU) including an interface with peripheral devices, a control device, a calculation unit, a register, and the like. For example, a control function of the estimation unit 13 of the advertisement budget optimization device 1 or the like may be realized by the processor 1001.

Further, the processor 1001 reads a program (program code), a software module, or data from the storage 1003 and/or the communication device 1004 into the memory 1002, and executes various processes according to the program, the software module, or the data. As the program, a program that causes a computer to execute at least some of operations described in the above-described embodiment is used. For example, the control function of the estimation unit 13 of the advertisement budget optimization device 1 or the like may be realized by a control program stored in the memory 1002 and operated by the processor 1001 or other functional blocks may be realized in the same manner. Although a case in which the various processes described above are executed by one processor 1001 has been described, the processes may be executed simultaneously or sequentially by two or more processors 1001. The processor 1001 may be mounted on one or more chips. The program may be transmitted from a network via a telecommunication line.

The memory 1002 is a computer-readable recording medium, and may be configured of at least one of a read only memory (ROM), an erasable programmable ROM (EPROM), an electrically erasable programmable ROM (EEPROM), and a random access memory (RAM). The memory 1002 may also be referred to as a register, a cache, a main memory (main storage device), or the like. The memory 1002 can store a program (program code), a software module, or the like that can be executed to implement a wireless communication method according to an embodiment of the present invention.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including the memory 1002 and/or the storage 1003, a server, or another appropriate medium.

The communication device 1004 is hardware (a transmission and reception device) for performing communication between computers via a wired network and/or a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 or the memory 1002 is connected by the bus 1007 for communicating information. The bus 1007 may be configured of a single bus or may be configured of different buses between devices.

Further, the advertisement budget optimization device 1 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be implemented using at least one of these pieces of hardware.

Although the present embodiment has been described in detail above, it is apparent to those skilled in the art that the present embodiment is not limited to the embodiments described in the present specification. The present embodiment can be implemented as a modified and changed aspect without departing from the spirit and scope of the present invention defined by the description of the claims. Accordingly, the description of the present specification is intended for the purpose of illustration and does not have any restrictive meaning with respect to the present embodiments.

Each aspect or embodiment described in the present specification may be applied to long term evolution (LTE), LTE-Advanced (LTE-A), SUPER 3G, IMT-Advanced, 4G, 5G, future radio access (FRA), W-CDMA registered trademark), GSM (registered trademark), CDMA2000, ultra mobile broad-band (UMB), IEEE 802.11 (Wi-Fi), IEEE 802.16 (WiMAX), IEEE 802.20, Ultra-Wide Band (UWB), Bluetooth (registered trademark), another system using an appropriate system, and/or a next generation system extended on the basis of these.

Processing procedure, flowchart, and the like in each aspect/embodiment described in the present specification may be in a different order unless inconsistency arises. For example, for the method described in the present specification, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present specification may be used alone, may be used in combination, or may be used by being switched according to execution. Further, a notification of predetermined information (for example, a notification of “being X”) is not limited to being made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called other names.

Further, software, instructions, and the like may be transmitted and received via a transmission medium. For example, when software is transmitted from a website, a server, or another remote source using a wired technology such as a coaxial cable, an optical fiber cable, a twisted pair, or a digital subscriber line (DSL) and/or a wireless technology such as infrared rays, radios, or microwaves, the wired technology and/or the wireless technology is included in the definition of the transmission medium.

The information, signals, and the like described in the present specification may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or any combination of these.

The terms described in the present disclosure and/or terms necessary for understanding of the present specification may be replaced by terms having the same or similar meanings.

Further, information, parameters, and the like described in the present specification may be represented by an absolute value, may be represented by a relative value from a predetermined value, or may be represented by corresponding different information.

A user terminal may be called a mobile communication terminal, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

The term “determining” used in the present disclosure may include a variety of operations. The “determining” can include, for example, regarding calculating, computing, processing, deriving, investigating, looking up (for example, looking up in a table, a database, or another data structure), or ascertaining as “determining”. Further, “determining” can include regarding receiving (for example, receiving information), transmitting (for example, transmitting information), inputting, outputting, or accessing (for example, accessing data in a memory) as “determining”. Further, “determining” can include regarding resolving, selecting, choosing, establishing, comparing, or the like as “determining”. That is, “determining” can include regarding a certain operation as “determining”.

The description “based on” used in the present specification does not mean “based only on” unless otherwise noted. In other words, the description “based on” means both of “based only on” and “at least based on”.

When the terms “first”, “second”, and the like are used in the present specification, any reference to elements thereof does not generally limit an amount or order of those elements. These terms can be used in the present specification as a convenient way to distinguish between two or more elements. Thus, the reference to the first and second elements does not mean that only two elements can be adopted or that the first element has to precede the second element in some way.

When “include”, “including” and modifications thereof are used in the present specification or claims, those terms are intended to be comprehensive like the term “comprising”. Further, the term “or” used in the present specification or claims is intended not to be an exclusive OR.

In the present specification, it is assumed that a plurality of devices are also included unless a single device is clearly indicated by the context or technically.

In the whole of the present disclosure, it is assumed that a plurality of things are included unless it is not cleared from the context that a singular thing is indicated.

### REFERENCE SIGNS LIST

1 Advertisement budget optimization device
13 Estimating unit
14 Determination unit

1. An advertisement budget optimization device comprising:
an estimation unit configured to estimate a cost per click of an advertisement for each predetermined unit period included in a delivery period of an advertisement campaign as a delivery target; and
a determination unit configured to determine an advertisement budget for each unit period so that a total number of clicks of the advertisement is maximized, based on the cost per click in each unit period estimated by the estimation unit and a total budget for the advertisement campaign in the delivery period.

2. The advertisement budget optimization device according to claim 1, wherein the estimation unit estimates the cost per click in each unit period of the advertisement campaign as a delivery target based on the cost per click in each unit period in each delivery time of the advertisement campaign having a high relevance to the advertisement campaign as a delivery target and delivered in the past.

3. The advertisement budget optimization device according to claim 1, wherein the estimation unit estimates the cost per click of the advertisement in each unit period in a period before advertisement delivery in the delivery period each time the unit period elapses after the delivery of the advertisement for the advertisement campaign as a delivery target is started.

4. The advertisement budget optimization device according to claim 3, wherein the estimation unit estimates the cost per click of the advertisement in each unit period in the period before advertisement delivery in the delivery period, based on the cost per click of the advertisement in each unit period for a period in which the delivery of the advertisement is completed.

5. The advertisement budget optimization device according to claim 1
wherein the advertisement campaign includes a plurality of advertisement groups set for respective types of approach to users, and
the determination unit performs allocation of the advertisement budget to each of the advertisement groups so that a larger budget is allocated to the advertisement group with a lower cost per click, based on the cost per click of each advertisement group for a period in which the delivery of the advertisement is completed.
